(19) United States
(12) Patent Application Publication
(10) Pub. No.: US 2021/0034869 A1
(43) Pub. Date: Feb. 4, 2021

(54) METHOD AND DEVICE FOR USING AUGMENTED REALITY IN TRANSPORTATION

(71) Applicant: DiDi Research America, LLC, Mountain View, CA (US)

(72) Inventors: Chaitanya DESAI, Mountain View, CA (US); Ted GRAJEDA, Tucson, AZ (US)

(21) Appl. No.: 16/525,955

(22) Filed: Jul. 30, 2019

(51) Int. Cl. G06K 9/00; G06F 16/58; G01C 21/20; G01C 21/36; G06T 7/70; G06T 19/00; H04W 4/029

(52) U.S. Cl. CPC G06K 9/00671; G06F 16/5866; G01C 21/20; G01C 21/3632; H04W 4/029; G01C 21/3635; G06T 7/70; G06T 19/006; G01C 21/367

(57) ABSTRACT

Augmented reality may be used to help navigate a user to a desired location. A first location and a device orientation of a user device may be obtained. A second location may be obtained. A path from the first location to the second location may be determined. A camera feed may be displayed on the user device. An indicator of the path may be displayed over the camera feed based on the device orientation. A marker may be displayed over the camera feed in response to determining that the device orientation aligns with the second location, and the marker may indicate the second location.

### TECHNICAL FIELD

The disclosure relates generally to providing navigation using augmented reality.

### BACKGROUND

People often make plans to meet in crowded areas. Finding each other can be difficult for both strangers and friends alike. It can be particularly difficult to find a person when the person is in a car. Passengers using a ride sharing platform may have difficulty locating their ride, even if they are within a short range of the car. A person's experience may be improved by providing improved navigation to help one person reach a desired location.

### SUMMARY

One aspect of the present disclosure is directed to a system for augmented reality navigation. The system may comprise one or more processors and one or more non-transitory computer-readable memories coupled to the one or more processors and configured with instructions executable by the one or more processors. Executing the instructions may cause the system to perform operations comprising: obtaining a first location and a device orientation of a user device; obtaining a second location; determining a path from the first location to the second location; displaying a camera feed on the user device; displaying, based on the device orientation, an indicator of the path over the camera feed; and displaying, in response to determining that the device orientation aligns with the second location, a marker over the camera feed, the marker indicating the second location.

Another aspect of the present disclosure is directed to a method for augmented reality navigation, comprising: obtaining a first location and a device orientation of a user device; obtaining a second location; determining a path from the first location to the second location; displaying a camera feed on the user device; displaying, based on the device orientation, an indicator of the path over the camera feed; and displaying, in response to determining that the device orientation aligns with the second location, a marker over the camera feed, the marker indicating the second location.

Yet another aspect of the present disclosure is directed to a non-transitory computer-readable storage medium configured with instructions executable by one or more processors to cause the one or more processors to perform operations comprising: obtaining a first location and a device orientation of a user device; obtaining a second location; determining a path from the first location to the second location; displaying a camera feed on the user device; displaying, based on the device orientation, an indicator of the path over the camera feed; and displaying, in response to determining that the device orientation aligns with the second location, a marker over the camera feed, the marker indicating the second location.

In some embodiments, displaying the indicator of the path may comprise: determining a direction of the second location relative to the device orientation, wherein the path from the first location to the second location comprises the direction of the second location; and displaying the indicator of the path in the direction of the second location.

In some embodiments, displaying the indicator of the path may comprise: determining a route from the first location to the second location, wherein the path from the first location to the second location comprises the route; detecting a feature in the camera feed correlating with the route; and displaying the indicator of the path over the feature in the camera feed.

In some embodiments, the feature in the camera feed may comprise a road leading to the second location.

In some embodiments, the indicator of the path may comprise animated arrows along the path.

In some embodiments, displaying the camera feed on the user device may comprise displaying the camera feed on a first portion of user device; a map may be displayed on a second portion of the user device; and at least a portion of the path may be displayed over the map.

In some embodiments, the marker indicating the second location may grow in size as a user of the user device moves closer to the second location.

In some embodiments, displaying the camera feed on the user device may comprise: displaying, in response to determining that the first location and second location are within a threshold distance, a button to enable a camera of the user device; and displaying the camera feed on the user device in response to detecting a selection of the button.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1A illustrates an example environment for augmented reality navigation, in accordance with various embodiments of the disclosure.

FIG. 1B illustrates an example computing system for augmented reality navigation, in accordance with various embodiments.

FIG. 2 illustrates an example display for launching the augmented reality navigation, in accordance with various embodiments of the disclosure.

FIG. 3 illustrates an example display of augmented reality navigation including an indicator of a path, in accordance with various embodiments of the disclosure.

FIG. 4 illustrates an example display of augmented reality navigation including a marker indicating a second location, in accordance with various embodiments of the disclosure.

FIG. 5 is a block diagram that illustrates a computer system upon which any of the embodiments described herein may be implemented.

FIG. 6 illustrates a flowchart of an example method for augmented reality navigation, according to various embodiments of the present disclosure.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

Techniques disclosed herein may improve a user experience by providing navigation using augmented reality. Navigation directions may be augmented over a camera feed on the user's device. For example, arrows may be overlaid across the ground in the camera feed to show the user the path they need to take. A marker may further be augmented over the exact location in the camera feed which the user is trying to reach. This can be particularly helpful when the user is a passenger using a pool ride sharing service in which the passenger has to walk to meet the car. Augmented reality may be used to allow users to quickly reach a desired location.

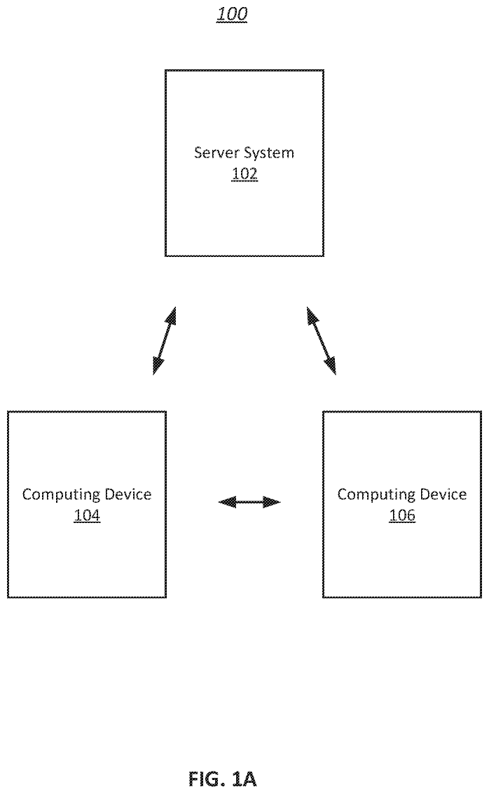

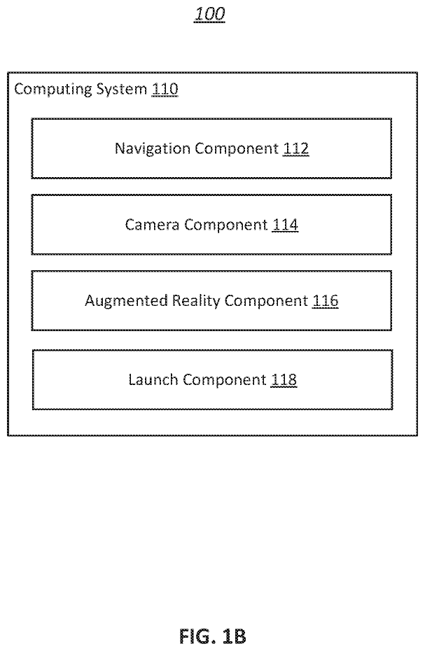

FIG. 1A illustrates an example environment 100 for augmented reality (AR) navigation, in accordance with various embodiments. The example environment 100 may include a server system 102, a computing device 104, and a computing device 106. It is to be understood that although two computing devices are shown in FIG. 1A, any number of computing devices may be included in the environment 100. Server system 102 may be implemented in one or more networks (e.g., enterprise networks), one or more endpoints, one or more servers, or one or more clouds. A server may include hardware or software which manages access to a centralized resource or service in a network. A cloud may include a cluster of servers and other devices which are distributed across a network. The computing devices 104 and 106 may be implemented on or as various devices such as mobile phone, tablet, server, desktop computer, laptop computer, wearable device (e.g., smart watch, helmet camera), dash cam, vehicle (e.g., car, truck, boat, train, autonomous vehicle, electric scooter, electric bike), etc. The server system 102 may communicate with the computing devices 104 and 106, and other computing devices. Computing devices 104 and 106 communicate with each other through server system 102, and may communicate with each other directly. Communication between devices may occur over the internet, through a local network (e.g., LAN), or through direct communication (e.g., BLUETOOTH™, radio frequency, infrared).

FIG. 1B illustrates an example computing system 110 for AR navigation, in accordance with various embodiments. Computing system 110 may be implemented in environment 100. While the computing system 110 is shown in FIG. 1B as a single entity, this is merely for ease of reference and is not meant to be limiting. One or more components or one or more functionalities of the computing system 110 described herein may be implemented in a single computing device or multiple computing devices. For example, computing system 110 may be entirely included in the server system 102 or the computing device 104 or 106. In another example, computing system 110 may be implemented across server system 102, computing device 104, and computing device 106.

In some embodiments, the computing system 110 includes a navigation component 112, a camera component 114, and an augmented reality component 116. In some embodiments the computing system 102, may further include a launch component 118. The computing system 110 may include other components. The computing system 110 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and memory (e.g., permanent memory, temporary memory). The processor(s) may be configured to perform various operations by interpreting machine-readable instructions stored in the memory. The computing system 110 may include other computing resources. In some implementations, computing system 110 may comprise a single self-contained hardware device configured to be communicatively coupled or physically attached to a component of a computer system. In some implementations, computing system 110 may include an application specific integrated circuit (ASIC) or a field-programmable gate array (FPGA) configured to perform transaction verification operations associated with one or more decentralized applications. The computing system 110 above may be installed with appropriate software (e.g., platform program, etc.) and/or hardware (e.g., wires, wireless connections, etc.) to access other devices of the environment 100.

The navigation component 112 may be configured to obtain locations and device orientations. A first location and a device orientation of a user device may be obtained. A second location may be obtained. In some embodiments, the second location may comprise a fixed destination. In some embodiments, the second location may comprise the location of a second device, and a second device orientation may be obtained. In some embodiments, the second device may comprise a user device. In some embodiments, the second device may comprise an autonomous or remote system which does not require user interaction. Obtaining information may include one or more of accessing, acquiring, analyzing, determining, examining, identifying, loading, locating, opening, receiving, retrieving, reviewing, storing, or otherwise obtaining the information.

In some embodiments, a first user device and a second device may include all or part of computing system 110. In some embodiments, a first user device comprises computing device 104, and a second device may comprise computing device 106. For example, the first user device may be a first user's mobile phone, and the second device may be second user's mobile phone. The first and second users may be pedestrians trying to locate one another, a rider and a drive trying to locate one another, or two drivers trying to locate one another. In another example, the first user device may be a first user's mobile phone, and the second device may be an autonomous vehicle. In another example, the first user device may be a wearable device.

Locations may comprise addresses, a landmark, or GPS (Global Positioning System) coordinates. In some embodiments, locations may be entered by a user. For example, a driver may pin the location of a nearby landmark. In another example, a rider may enter a location of a destination. In some embodiments, locations may be determined using GPS or access points connected to the devices. In some embodiments, locations may be determined using visual localization. Visual odometry, visual inertial odometry, or visual inertial telemetry may be used to track the location, orientation, and movement of the devices. Changes in position may be detected using sensors on the devices (e.g., camera, accelerometer, proximity sensor, gyroscope). A camera may be used to detect features and objects. For example, visual localization may use ARKIT™ or ARCORE™. The camera may comprise a camera connected to a device (e.g., mobile device camera, webcam), a dash cam, or a Six degrees of freedom (6 DoF) camera.

A database including topology and images may be used to identify detected features and objects. For example, the database may include topology maps and images of landmarks. In some embodiments, the database may include images of users and vehicles. For example, the database may include images of the driver's car, which the rider is trying to find. Images of all sides of the car may be uploaded to the database by the driver. Computing system 110 may perform all or part of the visual localization. In some embodiments, the database may be accessed by or located on one or more of server system 102, computing device 104, and computing device 106. For example, images may be captured by one or both of computing devices 104 and 106. In some embodiments, the images may be uploaded to server system 102. Server system 102 may perform the visual localization, and send location information back to one or both of computing devices 104 and 106. In some embodiments, visual localization may be performed locally at one or both of computing devices 104 and 106.

In some embodiments, both the first and second locations may be determined using visual localization. The first user and the second user may both turn on cameras on their user devices. Visual localization may be used to determine the location of the first user's device based on a feed from the first device's camera, and the location of the second user's device may be determined based on a feed from the second device's camera.

The navigation component 112 may be further configured to determine a path from the first location to the second location. For example, the path may be from a location of a rider to a location of a driver. In some embodiments, the path a be a direction of the second location relative to the device orientation. For example, the path may be a direction that a user of the first user device may turn to face the second location. The direction may be determined using the locations and the device orientation.

In some embodiment, the path may be a route from the first location to the second location. The route may comprise multiple steps that a user must take to reach the second location. For example, the route may include a list of turns the user must may including distances, directions, and street names.

The camera component 114 may be configured to display a camera feed on the user device. The camera feed may display a real-time feed from a camera. For example, live video from the camera may be displayed. The camera may comprise a device communicatively coupled to the user device (e.g., webcam, dash cam, video recorder, handheld camera) or a component embedded in the user device (e.g., mobile device camera).

The augmented reality component 116 may be configured to display an indicator of the path and a marker indicating the second location. The indicator and the marker may be displayed on the user device. The indicator and the marker may be augmented over the camera feed. The indicator may be displayed in response to determining that the device orientation does not align with the second location. For example, the indictor may be displayed when the camera of the user device is not pointed at the second location. In some embodiments, the indicator may be displayed in the direction leading to the second location. For example, an indicator may be displayed on the user device to indicate the direction the user must travel in order to reach the second location. The indicator may be displayed along the edge of the screen of the user device which is facing the second location. For example, an arrow may be displayed near the edge of the screen. The indicator may comprise displaying different colors if the user is moving toward or away from the second location. The indicator may comprise brightening and darkening the screen as the user is moves toward and away from the second location. For example, the edge of the screen closest to the second location may be brightened.

In some embodiments, the indicator may be displayed over a feature in the camera feed. The feature may be detected based on a correlation with a route from the first location to the second location. For example, the feature in the camera feed may comprise a road leading to the second device location. Animated arrows may be displayed along the path to the second location. For example, the arrows may move toward the second location. The arrows may show a rider the road or sidewalk they need to walk down in order to reach their driver. In some embodiments, the indicator may be displayed in response to determining that the device orientation does align with the second location. For example, the indicator may continue to be displayed after the device is turned to face the second location.

The marker indicating the second location may be displayed in response to determining that the device orientation aligns with the second location. For example, the marker may be displayed when the user device is facing the second location. The user device may be determined to be facing the second location when the second location is within the camera feed. The marker may be displayed within the camera feed. For example, the marker may be an icon marking a car a rider is trying to reach. The car may be identified using GPS or other localizing technologies. The marker may remain aligned with the second location as the user device moves. The marker may grow in size as the user device moves closer to the second location. Enlarging the marker may give a rider a sense of perspective as the rider moves closer to their car. The marker may be animated and colored. For example, an orange marker may spin or bounce on the second location, e.g., the car the rider is trying to reach.

In some embodiments, the augmented reality component 116 may be configured to display additional information in order to aid in navigation. The camera feed may be displayed over a first portion of the user device, and map may be displayed on a second portion of the user device. A portion of the path may be displayed over the map. For example, streets included in a route to the second device location may be highlighted in the map. The second location may be identified in the map. The second portion of the user device may comprise a navigation disc which includes the map. Compass style navigation may be displayed in the navigation disc or on a third portion of the user device. Text navigation information may be displayed on a fourth portion of the user device. For example, a distance, direction, and street name may be displayed at the top of the user device. The combination of displayed information may allow a rider to reach their car in a timely manner.

In some embodiments, traditional means of communication and identification may be displayed. For example, a name, photo, and car information (e.g., color, make, model, license plate) of a driver may be displayed. Buttons for communication channels may be displayed. Communication channels may include calling, texting, and video chat. For example, a feed from the camera of the other device may be displayed.

The launch component 118 may be configured to launch the AR navigation on the user device. Launching the AR navigation may include activating a camera connected to the user device, and displaying the camera feed on the user device. The camera feed may be launched based on a threshold distance. The threshold distance may include a set distance. For example, the threshold distance may be 100 meters from the second location, e.g., the rider's car. The threshold distance may also be set using a geofence. In some embodiments, the camera may be launched automatically when the user device is within a threshold distance of the second location. In some embodiments, a button to enable a camera of the user device may be displayed in response to determining that the first location and second location are within a threshold distance. The camera feed may be launched in response to detecting a selection of the button. For example, a user may press the button. The button to enable the camera may be displayed along with other features, such as a map, and buttons to call and text a driver. The launch component 118 may conserve the resources of the user device. Using GPS, the camera, and the accelerometer may be computationally intensive. The launch component may delay activation of the AR in order to limit the drain on a battery of the user device.

In some embodiment, a request may be sent from a remote server, e.g., the server system 102, to a second user device to launch a second camera. The request may launch the camera of the second device automatically, or prompt a user of the second device to launch the camera. For example, the prompt may include a button to enable the camera on a driver's device. In some embodiments, the driver's camera may be turned on automatically when the rider turns their camera on.

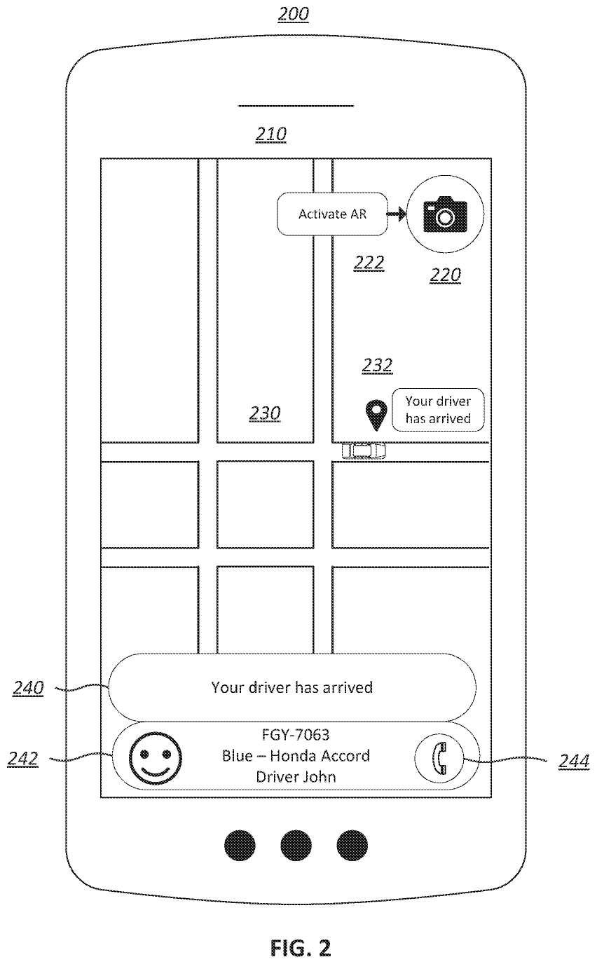

FIG. 2 illustrates an example display 210 of a user device 200 for launching the AR navigation. User device 200 may include all or part of computing device 104, computing device 106, or computing system 110. User device 200 may be used by a rider or a driver in a ride sharing trip. Display 210 may include a button 220 for launching AR navigation. For example, button 220 may be the button included in launch component 118 of FIG. 1B. A small text banner 222 may be included to explain the AR navigation feature. The text banner 222 may include language (e.g., “Use your camera to find your ride share car”) to prompt the user to launch the AR navigation. Clicking on text banner 222 may allow the user to learn more about AR. Display 210 includes a map 230 and a marker 232 which may show the location of a driver. Display 210 further includes a text notification section 240 displaying an alert to a rider letting the rider know the driver has arrived. Display 210 further includes a driver information section 242 that may include a name, photo, and car information of the driver. The driver information section 242 may include a button 244 that allows a rider to call and text the driver.

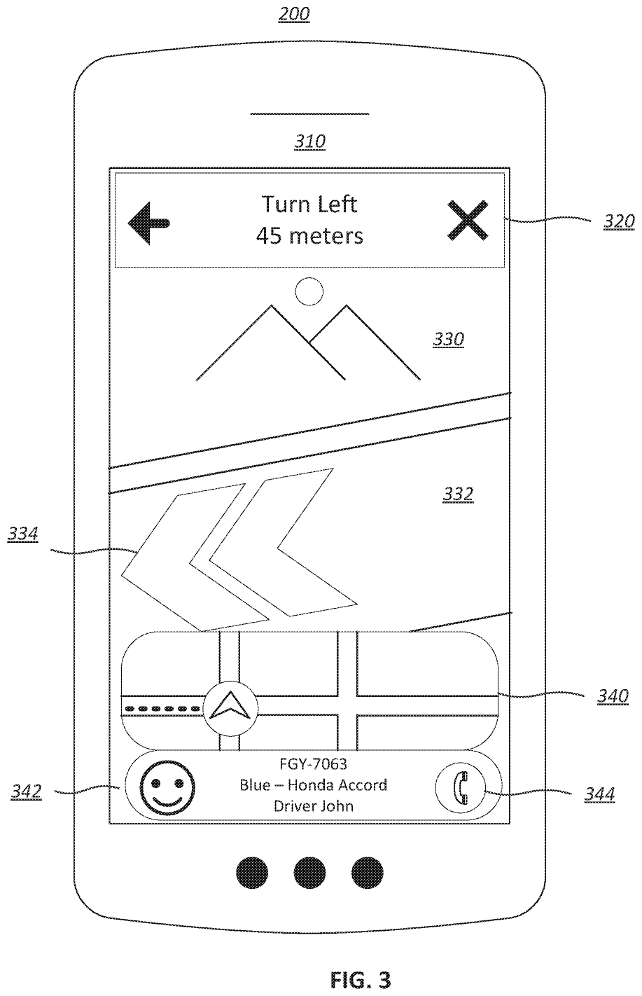

FIG. 3 illustrates an example display 310 of the user device 200 for displaying augmented reality navigation including an indicator of the path to the second location. Display 310 may include navigation information 320, camera feed 330, a map 340, and a driver information section 342. Navigation information 320 may include directions, distances, and an “X” to exit the augmented reality navigation. Camera feed 330 may be displayed. For example, camera feed 330 may be displayed using camera component 114 of FIG. 1B. Road 332 may be detected in camera feed 330 as part of the path leading to the second location. Arrows 334 may be augmented along road 332. For example, the arrows may be the indicator displayed by augmented reality component 116 of FIG. 1B. The map 340 may be displayed to provide the user with further navigation. Streets included in a route to the second location may be highlighted in the map. Driver information section 342 may include a name, photo, and car information of the driver. The driver information section 342 may include a button 344 that allows a rider to call and text the driver.

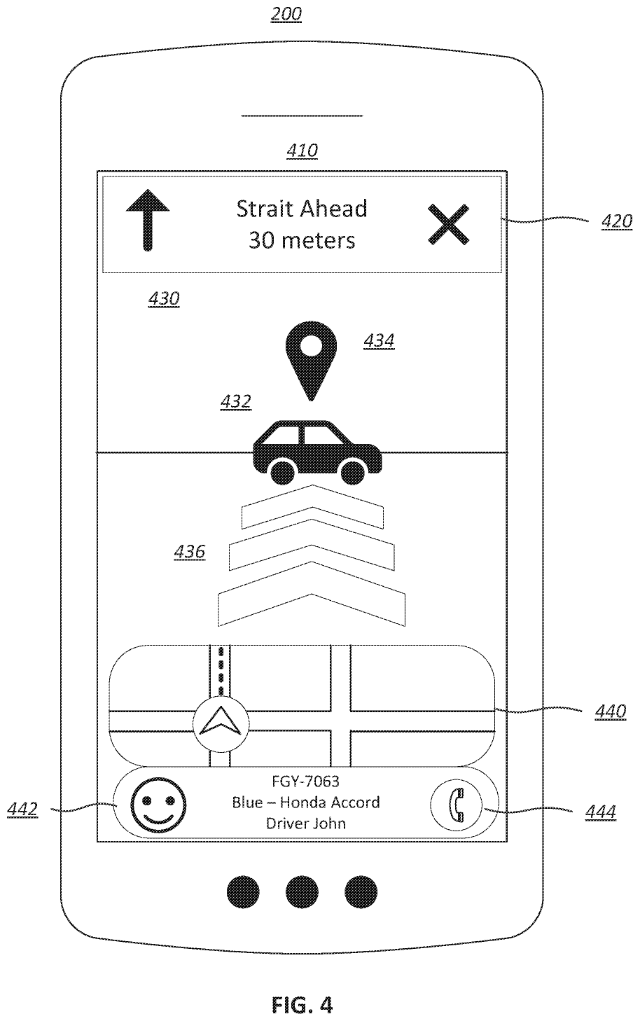

FIG. 4 illustrates an example display 410 of user device 200 for displaying augmented reality navigation including a marker indicating the second location. Display 410 may include navigation information 420, camera feed 430, a map 440, and a driver information section 442. Navigation information 420 may include directions, distances, and an “X” to exit the augmented reality navigation. In some embodiments, augmented reality navigation may be exited automatically when the driver initiates the trip. Camera feed 430 may be displayed. For example, camera feed 430 may be displayed using camera component 114 of FIG. 1B. Car 432 may be detected in camera feed 430 as the second location. Marker 434 may be augmented over camera feed 430 to indicate the location of car 432 in response to detecting the second location, e.g., the location of the car 432, in the camera feed 430. For example, the marker may be the marker displayed by augmented reality component 116 of FIG. 1B. Arrows 436 may be displayed along the path to car 432. Arrows 436 may comprise arrows 334, which have remained displayed as the device has turned to face the second location. Arrows 334 may be displayed along road 332. For example, the arrows 334 may be the indicator displayed by augmented reality component 116 of FIG. 1B. The map 440 may be displayed to provide the user with further navigation. Streets included in a route to the second location may be highlighted. Driver information section 442 may include a name, photo, and car information of the driver. The driver information section 442 may include a button 444 that allows a rider to call and text a driver.

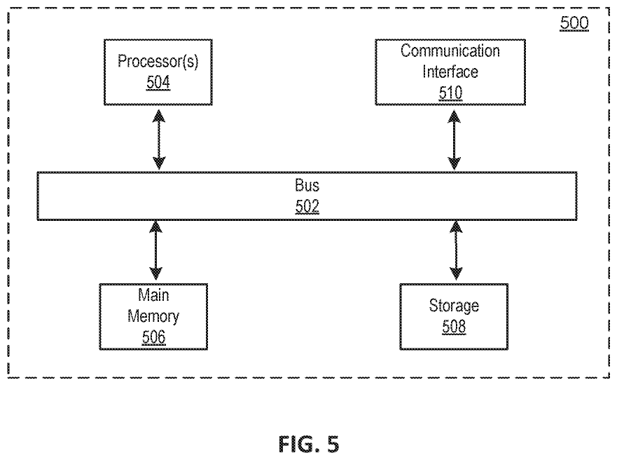

FIG. 5 is a block diagram that illustrates a computer system 500 upon which any of the embodiments described herein may be implemented. For example, the computer system 500 may be any one of the server system 102 and the computing devices 104 and 106. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor(s) 504. Main memory 506 also may be used for storing temporary variables or other intermediate information during execution of instructions to be executed by processor(s) 504. Such instructions, when stored in storage media accessible to processor(s) 504, render computer system 500 into a special-purpose machine that is customized to perform the operations specified in the instructions. Main memory 506 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 508. Execution of the sequences of instructions contained in main memory 506 causes processor(s) 504 to perform the process steps described herein. For example, the computing system 500 may be used to implement server system 102, computing device 104, and computing device 106 shown in FIG. 1A. In another example, the computing system 500 may be used to implement the computing system 110 or one or more components of the computing system 110 shown in FIG. 1B. In alternative embodiments, hard-wired circuitry may be used in place of or in combination with software instructions.

The computer system 500 also includes a communication interface 510 coupled to bus 502. Communication interface 510 provides a two-way data communication coupling to one or more network links that are connected to one or more networks. As another example, communication interface 510 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

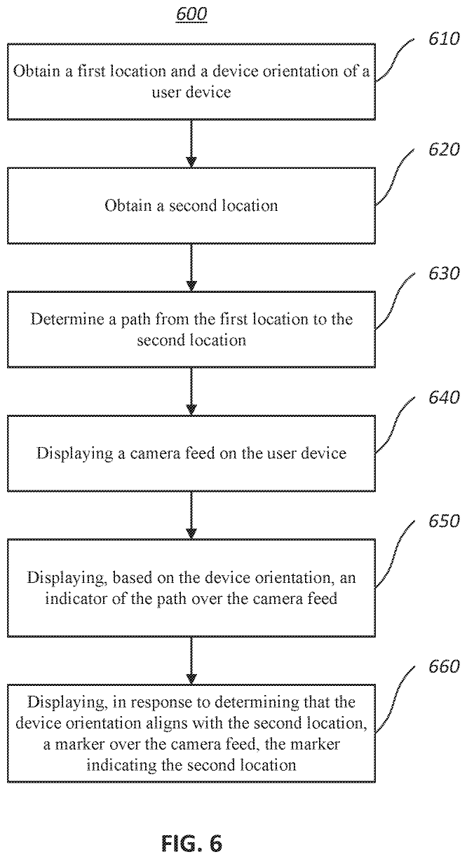

FIG. 6 illustrates a flowchart of an example method 600 for augmented reality navigation, according to various embodiments of the present disclosure. The method 600 may be implemented in various environments including, for example, the environment 100 of FIG. 1A and FIG. 1B. As another example, the process/method shown in FIG. 6 and described in connection with this figure may be implemented by computer program instructions stored in main memory 506 of FIG. 5. When these instructions are executed by processor(s) 504 of FIG. 5, they may perform the steps as shown in FIG. 6 and described above. The operations of the method 600 presented below are intended to be illustrative. Depending on the implementation, the method 600 may include additional, fewer, or alternative steps performed in various orders or in parallel. The method 600 may be implemented in various computing systems or devices including one or more processors.

With respect to the method 600, at block 610, a first location and a device orientation of a user device may be obtained. At block 620, a second location may be obtained. At block 630, a path from the first location to the second location may be determined. At block 640, a camera feed may be displayed on the user device. At block 650, an indicator of the path may be displayed over the camera feed based on the device orientation. At block 660, a marker may be displayed over the camera feed in response to determining that the device orientation aligns with the second location, and the marker may indicate the second location.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 110 may be described as performing or configured for performing an operation, when the components may comprise instructions which may program or configure the computing system 110 to perform the operation.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

1. A system for augmented reality navigation, comprising one or more processors and one or more non-transitory computer-readable memories coupled to the one or more processors and configured with instructions executable by the one or more processors to cause the system to perform operations comprising:
obtaining a first location and a device orientation of a user device;
displaying a first camera feed on the user device based on the first location of the user device being within a threshold distance of a second location;
sending a request to a second device to launch a second camera feed;
updating the first location of the user device based on first detected features in the first camera feed;
updating the second location based on second detected features in the second camera feed of the second device;
displaying at least one frame from the second camera feed on the user device;
determining a path from the first location of the user device to the second location;
displaying, based on the device orientation of the user device, an indicator of the path over the first camera feed; and
displaying, in response to determining that the device orientation aligns with the second location, a marker over the first camera feed, the marker indicating the second location.

2. The system of claim 1, wherein displaying the indicator of the path comprises:
determining a direction of the second location relative to the device orientation, wherein the path is from the first location to the second location and comprises the direction of the second location; and
displaying the indicator of the path in the direction of the second location.

3. The system of claim 1, wherein displaying the indicator of the path comprises:
determining a route from the first location to the second location, wherein the path is from the first location to the second location and comprises the route;
detecting a feature in the camera feed correlating with the route; and
displaying the indicator of the path over the feature in the camera feed.

4. The system of claim 3, wherein the feature in the camera feed comprises a road leading to the second location.

5. The system of claim 3, wherein the indicator of the path comprises animated arrows along the path.

6. The system of claim 1, wherein displaying the camera feed on the user device comprises displaying the camera feed on a first portion of the user device; and
the operations further comprise:
displaying a map on a second portion of the user device; and
displaying at least a portion of the path over the map.

7. The system of claim 1, wherein the marker indicating the second location grows in size as a user of the user device moves closer to the second location.

8. The system of claim 1, wherein displaying the camera feed on the user device comprises:
displaying, in response to determining that the first location and second location are within a threshold distance, a button to enable a camera of the user device; and
displaying the camera feed on the user device in response to detecting a selection of the button.

9. A method for augmented reality navigation, comprising:
obtaining a first location and a device orientation of a user device;
displaying a first camera feed on the user device based on the first location of the user device being within a threshold distance of a second location;
sending a request to a second device to launch a second camera feed;
updating the first location of the user device based on first detected features in the first camera feed;
updating the second location based on second detected features in the second camera feed of the second device;
displaying at least one frame from the second camera feed on the user device;
determining a path from the first location of the user device to the second location;
displaying, based on the device orientation of the user device, an indicator of the path over the first camera feed; and
displaying, in response to determining that the device orientation aligns with the second location, a marker over the first camera feed, the marker indicating the second location.

10. The method of claim 9, wherein displaying the indicator of the path comprises:
determining a direction of the second location relative to the device orientation, wherein the path is from the first location to the second location and comprises the direction of the second location; and
displaying the indicator of the path in the direction of the second location.

11. The method of claim 9, wherein displaying the indicator of the path comprises:
determining a route from the first location to the second location, wherein the path is from the first location to the second location and comprises the route;
detecting a feature in the camera feed correlating with the route; and
displaying the indicator of the path over the feature in the camera feed.

12. The method of claim 11, wherein the feature in the camera feed comprises a road leading to the second location.

13. The method of claim 11, wherein the indicator of the path comprises animated arrows along the path.

14. The method of claim 9, wherein displaying the camera feed on the user device comprises displaying the camera feed on a first portion of the user device; and
the method further comprises:
displaying a map on a second portion of the user device; and
displaying at least a portion of the path over the map.

15. The method of claim 9, wherein the marker indicating the second location grows in size as a user of the user device moves closer to the second location.

16. The method of claim 9, wherein displaying the camera feed on the user device comprises:
displaying, in response to determining that the first location and second location are within a threshold distance, a button to enable a camera of the user device; and
displaying the camera feed on the user device in response to detecting a selection of the button.

17. A non-transitory computer-readable storage medium configured with instructions executable by one or more processors to cause the one or more processors to perform operations comprising:
obtaining a first location and a device orientation of a user device;
displaying a first camera feed on the user device based on the first location of the user device being within a threshold distance of a second location;
sending a request to a second device to launch a second camera feed;
updating the first location of the user device based on first detected features in the first camera feed;
updating the second location based on second detected features in the second camera feed of the second device;
displaying at least one frame from the second camera feed on the user device;
determining a path from the first location of the user device to the second location;
displaying, based on the device orientation of the user device, an indicator of the path over the first camera feed; and
displaying, in response to determining that the device orientation aligns with the second location, a marker over the first camera feed, the marker indicating the second location.

18. The non-transitory computer-readable storage medium of claim 17, wherein displaying the indicator of the path comprises:
determining a route from the first location to the second location, wherein the path is from the first location to the second location and comprises the route;
detecting a feature in the camera feed correlating with the route; and
displaying the indicator of the path over the feature in the camera feed.

19. The non-transitory computer-readable storage medium of claim 18, wherein the feature in the camera feed comprises a road leading to the second location.

20. The non-transitory computer-readable storage medium of claim 17, wherein displaying the camera feed on the user device comprises displaying the camera feed on a first portion of the user device; and
the operations further comprise:
displaying a map on a second portion of the user device; and
displaying at least a portion of the path over the map.
